(19) United States
(12) Patent Application Publication
(10) Pub. No.: US 2026/0203354 A1
(43) Pub. Date: Jul. 16, 2026

(54) ELECTRONIC DEVICE AND DOCUMENT SEARCH METHOD THEREOF

(71) Applicant: ASUSTeK COMPUTER INC., Taipei City (TW)

(72) Inventors: Shih-Wei Su, Taipei City (TW); Szu-Wei Chang, Taipei City (TW); Wei-Hao Lee, Taipei City (TW)

(73) Assignee: ASUSTeK COMPUTER INC., Taipei City (TW)

(21) Appl. No.: 19/389,056

(22) Filed: Nov. 14, 2025

(30) Foreign Application Priority Data
Jan. 13, 2025 (TW) 114101254

(51) Int. Cl. G06F 16/903; G06F 16/93; G06F 40/166; G06F 40/40

(52) U.S. Cl. CPC G06F 16/90335; G06F 16/93; G06F 40/166; G06F 40/40

(57) ABSTRACT

An electronic device and an document search method thereof are provided. The method is adapted to the electronic device storing documents and includes the following steps. A plurality of document content segments of each of the documents are obtained. A generative model is utilized to generate summary texts respectively corresponding to the document content segments of each of the documents. A natural language model is employed to generate semantic feature vectors for the summary texts of each document, and the semantic feature vectors of each document are recorded in a database. A search description is obtained through an input device, and a natural language model is utilized to generate a search feature vector of the search description. By comparing the search feature vector with the semantic feature vectors of each document stored in the database, at least one target document related to the search description is determined from the documents.

### CROSS-REFERENCE TO RELATED APPLICATION

This application claims the priority benefit of Taiwan application serial no. 114101254, filed on January 13, 2025. The entirety of the above-mentioned patent application is hereby incorporated by reference herein and made a part of this specification.

### BACKGROUND

### Technical Field

This disclosure relates to an electronic device and a document search method thereof.

### Related Art

Currently, when a user wants to find a specific document stored in a mobile device, they may search by inputting keywords to obtain specific documents with names or contents include the keywords. Although users may search for documents using keywords, they must enter highly precise keywords to accurately locate the specific documents they need. Therefore, users may spend time trying multiple keywords to obtain search results that meet their requirements. They may even encounter situations where they spend lots of time and still cannot find the truly needed documents. Especially when users only have a vague impression of the content of a document and cannot input precise keywords, the probability of successful search is even lower. When users can only filter and search through the document list one by one, and the search process becomes time-consuming.

### SUMMARY

This disclosure provides a document search method adapted to an electronic device storing a plurality of documents. This method includes the following steps. A plurality of document content segments of each of the documents are obtained. A plurality of summary texts corresponding to the document content segments of each document are generated by utilizing a generative model. A plurality of semantic feature vectors of the summary texts for each document are generated by utilizing a natural language model, and the semantic feature vectors of each document are recorded to a database. A search description is obtained via an input device, and a search feature vector of the search description is generated by utilizing the natural language model. At least one target document related to the search description is determined from the documents by comparing the search feature vector with the semantic feature vectors of each document in the database.

This disclosure provides an electronic device, including an input device, a storage device, and a processor. The storage device records multiple instructions and stores multiple documents. The processor is coupled to the input device and the storage device, and is configured to execute the aforementioned instructions to perform the following operations. A plurality of document content segments of each of the documents are obtained. A plurality of summary texts corresponding to the document content segments of each document are generated by utilizing a generative model. A plurality of semantic feature vectors of the summary texts for each document are generated by utilizing a natural language model, and the semantic feature vectors of each document are recorded to a database. A search description is obtained via an input device, and a search feature vector of the search description is generated by utilizing the natural language model. At least one target document related to the search description is determined from the documents by comparing the search feature vector with the semantic feature vectors of each document in the database.

Based on the above, in an embodiment of the disclosure, the text summarization function of the generative model is utilized to extract key summary texts of each document content segment, and convert the key summary texts of each document content segment into semantic feature vectors, which are stored in a database. When a search description is received from a user, the natural language model may be utilized to convert the search description into a search feature vector. Subsequently, by comparing the search feature vector with the semantic feature vectors of each document content segment of each document in the database, one or more target document(s) matching the search description may be obtained. Since generative models can generate semantic feature vectors based on a deep understanding of document content, they effectively reduce inaccuracies in search results caused by semantic misunderstandings or variations in synonyms. Furthermore, when using a multimodal large language model to extract key summary texts from different document segments, the model can not only comprehend images within the documents but also understand the corresponding textual content. As a result, more precise key summary texts can be produced.

### BRIEF DESCRIPTION OF THE DRAWINGS

FIG. 1 is a block diagram illustrating an electronic device according to an embodiment of the disclosure.

FIG. 2 is a flowchart illustrating a document search method according to an embodiment of the disclosure.

FIG. 3 is a schematic diagram illustrating a document search method according to an embodiment of the disclosure.

FIG. 4 is a schematic diagram illustrating the generation of semantic feature vectors and the determination of feature similarity according to an embodiment of the disclosure.

FIG. 5 is a flowchart illustrating a document search method according to an embodiment of the disclosure.

FIG. 6 is a flowchart illustrating the generation of integrated text according to an embodiment of the disclosure.

FIG. 7A to FIG. 7C are schematic diagrams illustrating the generation of integrated text according to an embodiment of the disclosure.

FIG. 8 is a schematic diagram illustrating the establishment of a feature vector database according to an embodiment of the disclosure.

### DESCRIPTION OF THE EMBODIMENTS

Reference will now be made in detail to the exemplary embodiments of the disclosure, examples of which are illustrated in the accompanying drawings. Whenever possible, the same component symbols are used in the drawings and descriptions to represent the same or similar parts. The embodiments are only part of the present disclosure and do not reveal all possible implementation modes of the present disclosure. Rather, the embodiments are merely examples of devices and methods within the scope of the disclosure.

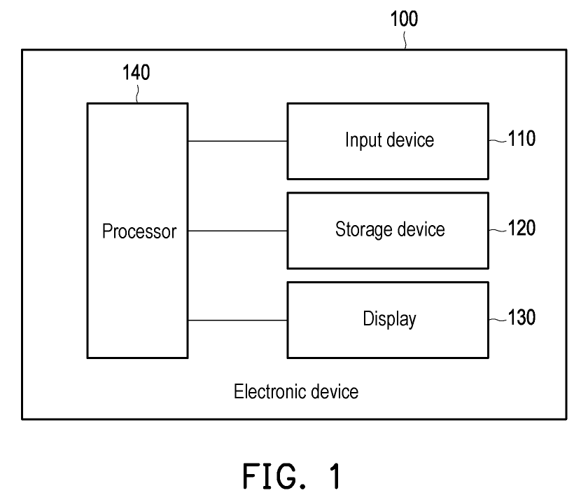

Referring to FIG. 1, in an embodiment, the electronic device 100 may include an input device 110, a storage device 120, a display 130, and a processor 140. In some embodiments, the electronic device 100 is a smartphone, a laptop computer, a tablet computer, a desktop computer, or a smart wearable device, etc., but the disclosure is not limited thereto.

The input device 110 is configured to receive user input. In some embodiments, the input device 110 is a touch input device, keyboard, mouse, or microphone, etc., but the disclosure is not limited thereto. In an embodiment, the input device 110 is configured to receive search descriptions input by the user.

The storage device 120 is configured to store data and software modules (such as operating systems, applications, drivers) for the processor 140 to access. In some embodiments, the storage device 120 is any form of fixed or removable random access memory (RAM), read-only memory (ROM), flash memory, hard disk, or a combination thereof.

In some embodiments, the display 130 is a Liquid Crystal Display (LCD), Light-Emitting Diode (LED) display, Organic Light-Emitting Diode (OLED) display, or other types of displays, but the disclosure is not limited thereto. In an embodiment, the display 130 displays a user interface for receiving search descriptions, and also displays search results.

The processor 140 is coupled to the input device 110, the storage device 120, and the display 130. In some embodiments, the processor 140 is a central processing unit (CPU), application processor (AP), or other programmable general-purpose or special-purpose microprocessor, digital signal processor (DSP), image signal processor (ISP), graphics processing unit (GPU) or similar devices, integrated circuits and combinations thereof. In some embodiments, the processor 140 accesses and executes software modules recorded in the storage device 120 to implement the document search method in an embodiment. In some embodiments, the aforementioned software modules is broadly interpreted to mean instructions, instruction sets, code, program code, programs, applications, software packages, threads, processes, functions, etc., regardless of whether they are referred to as software, firmware, middleware, microcode, hardware description language, or otherwise.

In an embodiment, the electronic device 100 may utilize the storage device 120 to store multiple documents. When a user inputs a search description via the input device 110, the electronic device 100 may provide search results including one or more target documents relevant to the search description. Thus, in some embodiments, based on the search results displayed on the display 130, the user may directly use the target document (for example, open the target document or send the target document, etc.) without spending time searching through numerous possible storage locations to find the target document.

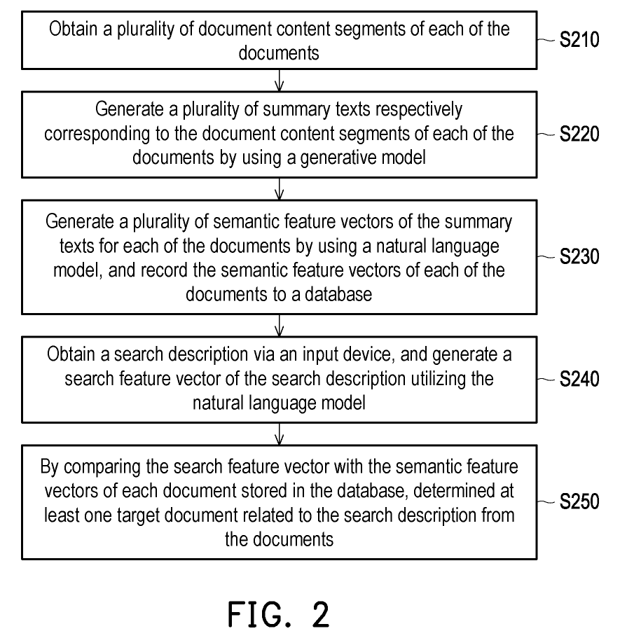

Referring to both FIG. 1 and FIG. 2, the method of an embodiment is applicable to the aforementioned electronic device 100. The following will explain the detailed steps of the document search method in an embodiment in conjunction with the various components of the electronic device 100.

In step S210, the processor 140 may obtain a plurality of document content segments of each of the documents. In some embodiments, the documents stored in the storage device 120 may be documents of various file formats. In some embodiments, the documents is PDF files, WORD files, or TXT files, etc., but the disclosure is not limited thereto. The document content of the documents may include text content, image content, or a combination thereof. The processor 140 may utilize a document parser to extract the document content of each document, and divide the document content of each document into multiple document content segments.

For example, the processor 140 may divide the document content into multiple document content segments based on the number of pages in the document, wherein each document content segment is the content of a certain page of a document. However, the disclosure is not limited to dividing document content based on page numbers. The processor 140 may also divide document content based on paragraphs, chapters, specific markers, or document structure. For example, the processor 140 may divide the document content into multiple document content segments based on paragraphs, where each document content segment is the content of multiple paragraphs of a certain document.

In step S220, the processor 140 may generate multiple summary texts respectively corresponding to the document content segments of each document by utilizing a generative model. Specifically, the processor 140 may input a prompt requesting content summarization along with the document content segments into the generative model. The generative model may generate summary texts for each of the document content segments respectively according to the prompt.

In some embodiments, the generative model may include a Multimodal Large Language Model (Multimodal LLM). The Multimodal LLM can generate text output based on input text, input images, or a combination thereof. Multimodal LLMs are artificial intelligence models capable of processing multiple types of data (such as text and images) simultaneously. Multimodal models can accept text and other types of data as input, and generate appropriate output based on the multimodal input. For example, a Multimodal LLM can generate descriptive text for input images. For instance, a Multimodal LLM can generate descriptive text or content summaries for input images and their corresponding text. In an embodiment, the processor 140 may utilize a Multimodal LLM to generate multiple summary texts corresponding to each of the document content segments.

In some embodiments, the processor 140 may first use the Multimodal LLM to understand the document content segment, and then utilize the Multimodal LLM to generate summary text based on the model's understanding of the content. Therefore, regardless of whether each document content segment is pure text content, pure image content, or text-image hybrid content, the processor 140 can utilize the Multimodal Large Language Model to generate summary text that accurately reflects the key information of the document.

In some embodiments, the generative model may generate summary text for one of the document content segments based on consecutive document content segments, in order to produce more accurate summary text while preserving contextual information. For example, the generative model may generate summary text for the document content segment of the i-th page based on the summary text of the document content segment of the (i-1)-th page and the document content segment of the i-th page. This summarization method can reduce the potential loss of summary information that may result from processing segmented content individually, thereby generating summary text with strong contextual relevance.

In step S230, the processor 140 may generate multiple semantic feature vectors of the summary texts for each document by using a natural language model, and records the semantic feature vectors of each document in a database. The natural language model can be configured to convert input text into semantic feature vectors in a multi-dimensional feature space. In different implementations, the natural language model is a BERT (Bidirectional Encoder Representations from Transformers) model, a GPT (Generative Pre-trained Transformer) model, a Bag-of-Words Model, or a USE (Universal Sentence Encoder) model, etc. The disclosure does not limit the choice of model. In some embodiments, the model parameters of the natural language model is stored in the storage device 120.

For example, when a document includes 5 document content segments, the processor 140 may utilize the natural language model to convert the 5 summary texts of the 5 document content segments into 5 semantic feature vectors respectively, to generate 5 semantic feature vectors for this document. Subsequently, the processor 140 may record the semantic feature vectors of all documents in a feature vector database. For instance, the processor 140 may store the semantic feature vectors in the feature vector database in a structural form of <vector/page number/document name>, ensuring that each semantic feature vector can be associated with its corresponding page number and document name. This storage method facilitates subsequent retrieval and application, enabling quick location of semantic information for specific pages or documents, thereby improving the query efficiency and accuracy of the system.

In step S240, the processor 140 may obtain a search description via the input device 110, and utilizes the natural language model to generate a search feature vector of the search description. The user may input the search description through voice input or typing input. For example, the user may use the input device 110 to enter the search description in an input field of a user operation interface displayed on the display 130. Alternatively, the user may speak the search description, and the processor 140 may receive the voice input through the input device 110. The search description may include one word or multiple words; The disclosure does not limit this. Furthermore, the processor 140 may input the search description into the natural language model to generate a corresponding search feature vector. The search feature vector is the semantic feature vector of the search description. In other words, the natural language model may convert the search description into a search feature vector in a multi-dimensional feature vector space.

In step S250, the processor 140 may determine at least one target document related to the search description from multiple documents by comparing the search feature vector with the semantic feature vectors of each document in the database.

In some embodiments, the processor 140 may calculate multiple feature similarities between the search feature vector and the semantic feature vectors of each document. In some embodiments, the processor 140 may calculate the feature similarity between the search feature vector and each semantic feature vector of each document. For example, the processor 140 may calculate the cosine similarity, Euclidean Distance, or Manhattan Distance between the search feature vector and each semantic feature vector to generate the feature similarity between two feature vectors.

In some embodiments, the processor 140 may determine at least one target document related to the search description from multiple documents based on the feature similarities corresponding to each document. Specifically, the document search result may include at least one of multiple documents. In some embodiments, the processor 140 may compare the feature similarities with a preset threshold respectively, and filter out the target document based on the comparison result.

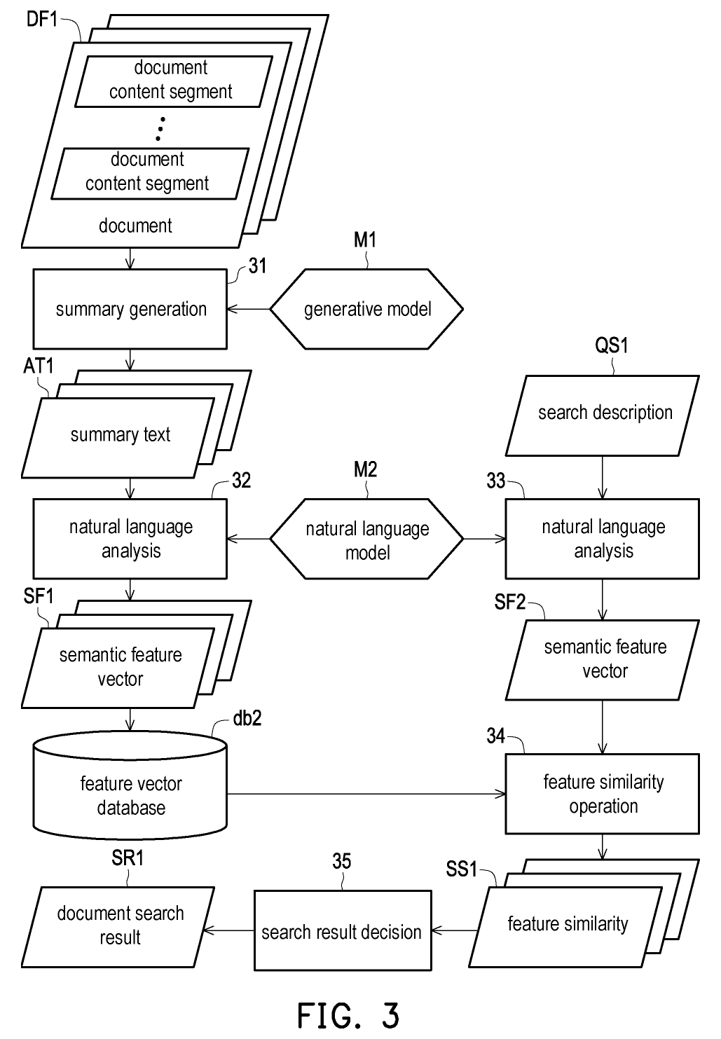

Referring to FIG. 3, which is a schematic diagram of the document search method illustrated according to an embodiment of the disclosure. The electronic device 100 may store multiple documents DF1 and obtain document content segment of each document DF1. In the summary generation operation 31, the processor 140 may utilize the generative model M1 to generate summary text AT1 for each document content segment. In the natural language analysis operation 32, the processor 140 utilizes the natural language model M2 to convert the summary texts AT1 into multiple corresponding semantic feature vectors SF1, and the semantic feature vectors SF1 of each document DF1 is recorded in the feature vector database db2.

On the other hand, in the natural language analysis operation 33, the processor 140 utilizes the natural language model M2 to convert the search description QS1 into a corresponding search feature vector SF2. In the feature similarity operation 34, the processor 140 calculates the feature similarity SS1 between the search feature vector SF2 and each semantic feature vector SF1. In the search result decision operation 35, the processor 140 determines the document search result SR1 based on the feature similarity SS1 corresponding to each document DF1. In some embodiments, t he document search result SR1 includes at least one target document.

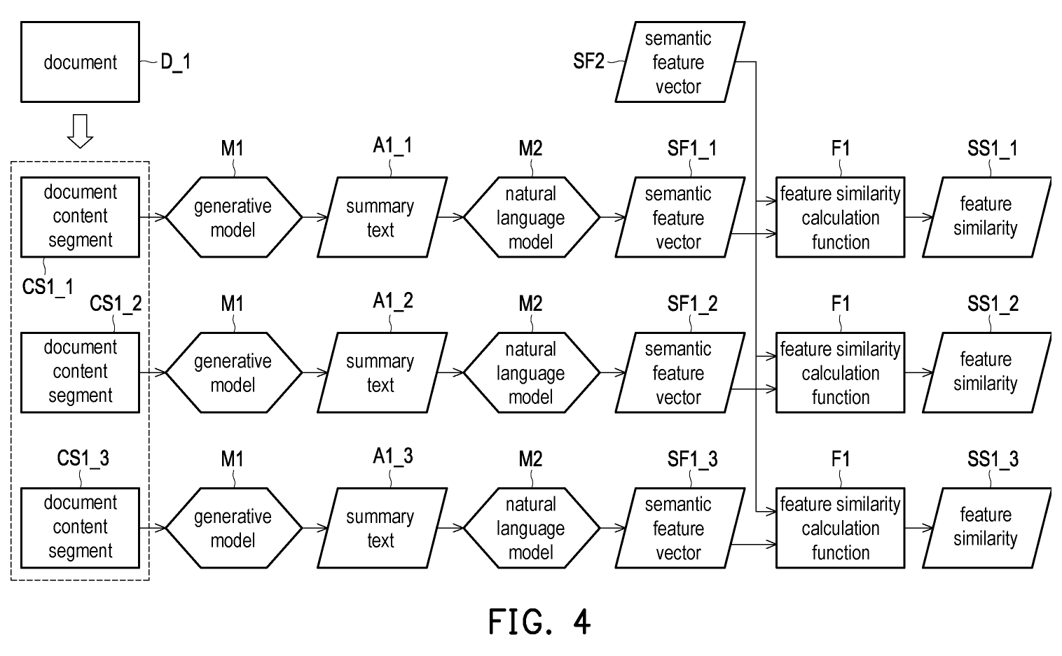

Referring to FIG. 4, which is a schematic diagram illustrating the generation of semantic feature vectors and determination of feature similarities according to an embodiment of the disclosure. In the embodiment, the processor 140 obtains 3 document content segments CS1_1 to CS1_3 of a certain document D_1. The processor 140 utilizes the generative model M1 to obtain 3 summary texts A1_1 to A1_3 corresponding to the 3 document content segments CS1_1 to CS1_3 respectively. Then, the processor 140 uses the natural language model M2 to convert the 3 summary texts A1_1 to A1_3 into 3 semantic feature vectors SF1_1 to SF1_3. Thus, the processor 140 utilizes the feature similarity calculation function F1 to calculate the feature similarities SS1_1 to SS1_3 between the semantic feature vectors SF1_1 to SF1_3 and the search feature vector SF2 respectively, to obtain the feature similarities SS1_1 to SS1_3 corresponding to document D_1.

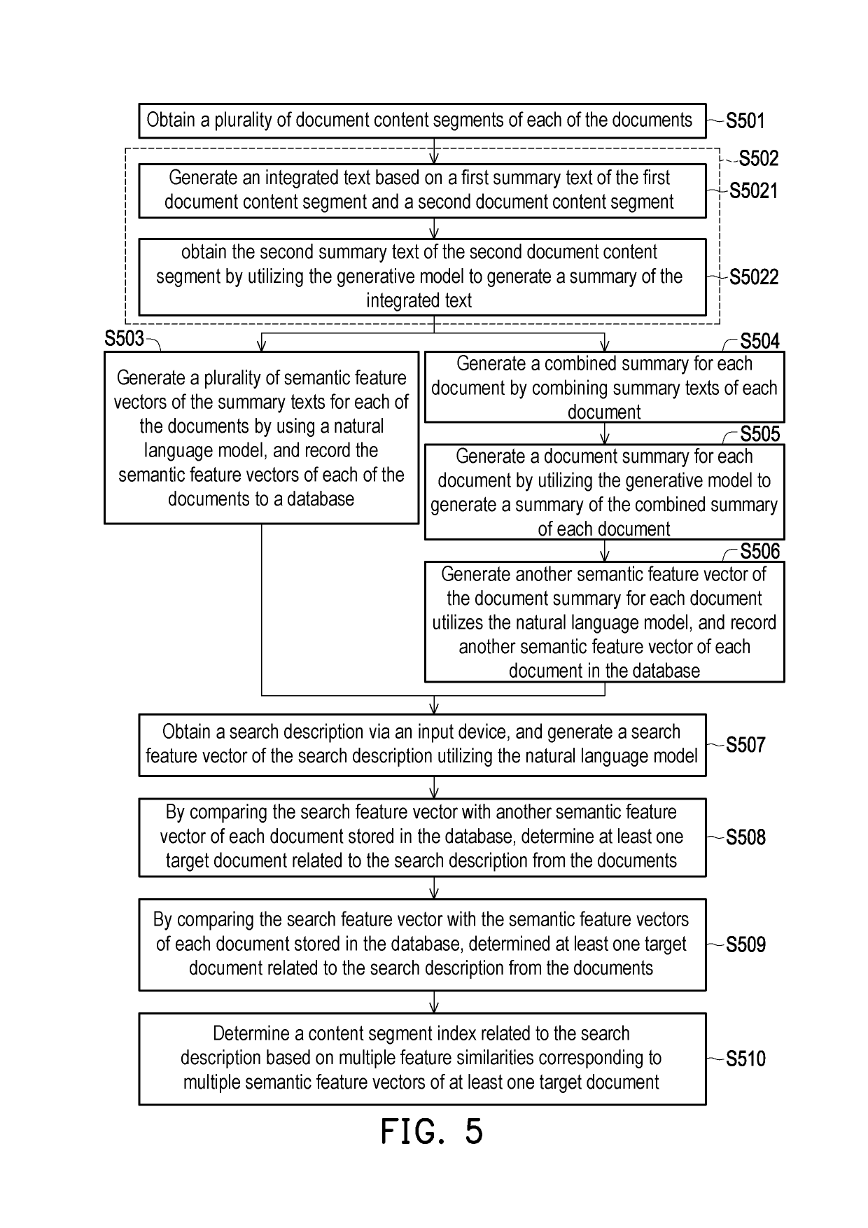

Referring to both FIG. 1 and FIG. 5 simultaneously. The method of an embodiment is applicable to the electronic device 100 described above. The following explains the detailed steps of the document search method of an embodiment in conjunction with various components of the electronic device 100.

In step S501, the processor 140 obtains a plurality of document content segments of each document. In step S502, the processor 140 generates multiple summary texts corresponding respectively to the document content segments of each document by utilizing the generative model. In some embodiments, step S502 includes step S5021 and step S5022.

In step S5021, the processor 140 generates an integrated text based on the first summary text of the first document content segment and the second document content segment. The first document content segment and the second document content segment are consecutive content of the same document. In step S5022, the processor 140 obtains the second summary text of the second document content segment by utilizing the generative model to generate a summary of the integrated text.

In some embodiments, the first document content segment is the document content segment of the (i-1)^{th} page of a certain document, while the second document content segment is the document content segment of the i^{th} page of the same document, where i is greater than 1. The second document content segment is pure text content, pure image content, or a text-image hybrid content. For the different types of content, the processor 140 adopts different processing methods to generate the integrated text by combining the previous summary text with the content of the second document content segment.

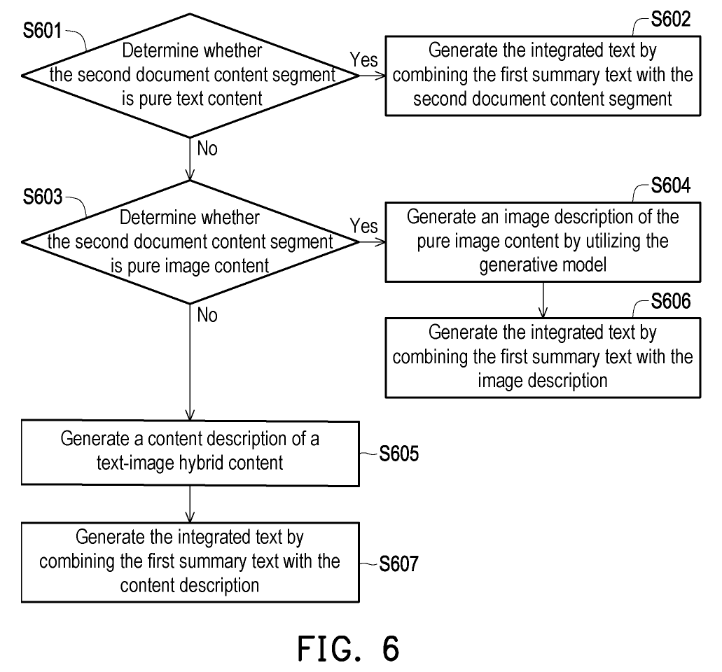

Referring to FIG. 6, which is a flowchart illustrating the process of generating an integrated text according to an embodiment of the disclosure. In step S601, the processor 140 determines whether the second document content segment is pure text content. When the second document content segment is pure text content (step S601 determined as yes), in step S602, the processor 140 generates the integrated text by combining the first summary text with the second document content segment.

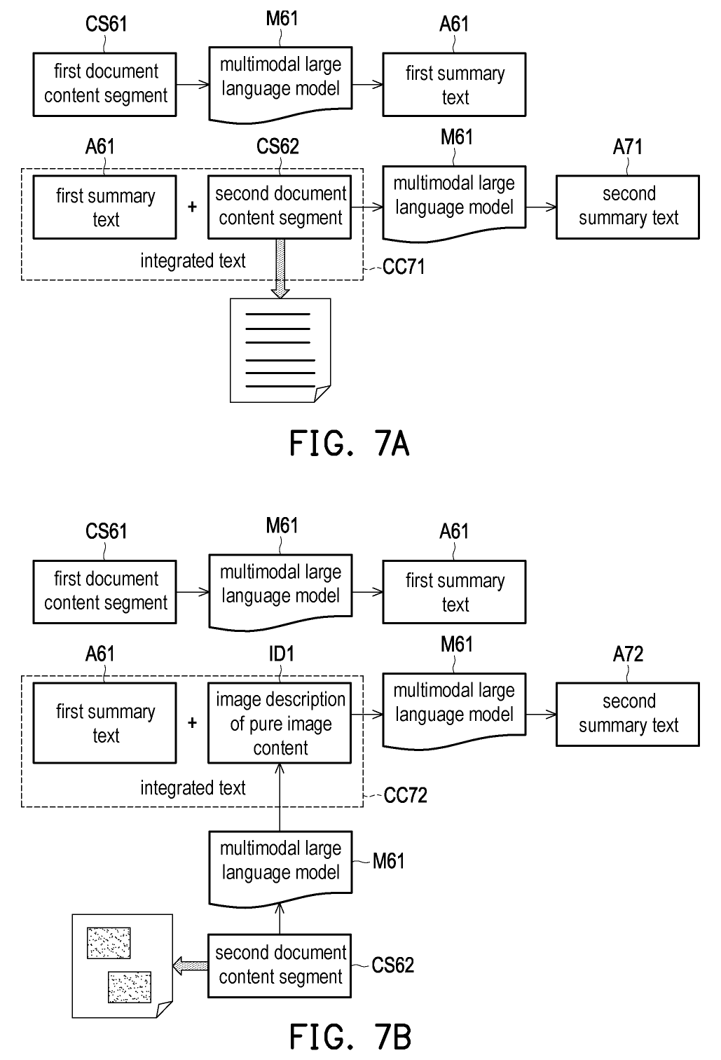

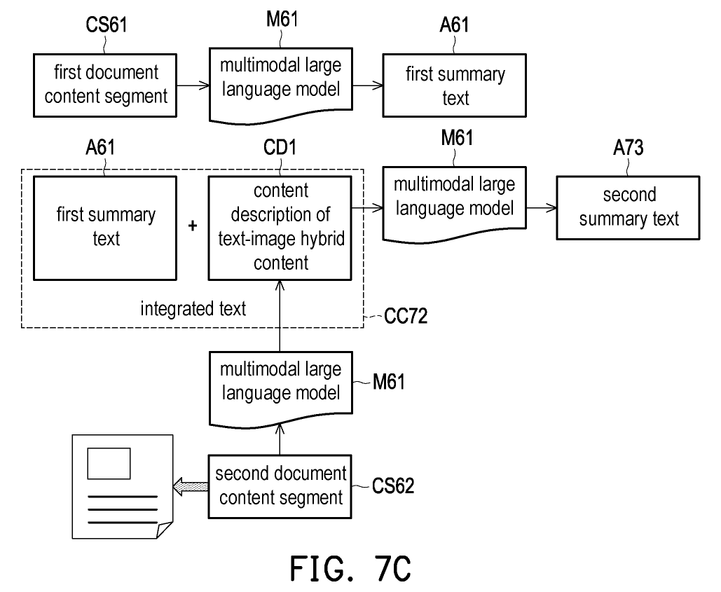

Referring to FIG. 7A, assuming that the first document content segment CS61 is the document's opening content. In the embodiment, the processor 140 inputs the first document content segment CS61 and corresponding prompt into the multimodal large language model M61, so that the multimodal large language model M61 outputs the first summary text A61. When the second document content segment CS62 following the first document content segment CS61 is pure text content, the processor 140 directly concatenates the first summary text A61 with the second document content segment CS62 to generate the integrated text CC71. The processor 140 inputs the integrated text CC71 and corresponding prompt into the multimodal large language model M61, so that the multimodal large language model M61 outputs the second summary text A71.

When the second document content segment is not pure text content (step S601 determined as no), in step S603, the processor 140 determines whether the second document content segment is pure image content. When the second document content segment is pure image content (step S603 determined as yes), in step S604, the processor 140 utilizes the generative model to generate an image description of the pure image content. In step S606, the processor 140 generates the integrated text by combining the first summary text with the image description.

Referring to FIG. 7B, assuming that the first document content segment CS61 is the document's opening content. In the embodiment, the processor 140 inputs the first document content segment CS61 and corresponding prompt into the multimodal large language model M61, so that the multimodal large language model M61 outputs the first summary text A61. When the second document content segment CS62 following the first document content segment CS61 is pure image content, the processor 140 inputs the second document content segment CS62 and corresponding prompt into the multimodal large language model M61, so that the multimodal large language model M61 outputs the image description ID1 of the second document content segment CS62. Afterwards, the processor 140 directly concatenates the first summary text A61 with the image description ID1 to generate the integrated text CC72. The processor 140 inputs the integrated text CC72 and corresponding prompt into the multimodal large language model M61, so that the multimodal large language model M61 outputs the second summary text A72.

When the second document content segment is text-image hybrid content (both step S602 and step S603 determined as no), in step S605, the processor 140 utilizes the generative model to generate a content description of the text-image hybrid content. In step S607, the processor 140 generates the integrated text by combining the first summary text with the content description.

Referring to FIG. 7C, assuming that the first document content segment CS61 is the document's opening content. In the embodiment, the processor 140 inputs the first document content segment CS61 and corresponding prompt into the multimodal large language model M61, so that the multimodal large language model M61 outputs the first summary text A61. When the second document content segment CS62 following the first document content segment CS61 is text-image hybrid content, the processor 140 inputs the second document content segment CS62 and corresponding prompt into the multimodal large language model M61, so that the multimodal large language model M61 outputs the content description CD1 of the text-image hybrid content. Afterwards, the processor 140 directly concatenates the first summary text A61 with the content description CD1 to generate the integrated text CC73. The processor 140 inputs the integrated text CC73 and corresponding prompt into the multimodal large language model M61, so that the multimodal large language model M61 outputs the second summary text A73.

Returning to FIG. 5, in step S503, the processor 140 utilizes a natural language model to generate multiple semantic feature vectors of multiple summary texts for each document, and records the semantic feature vectors of each document in the database. The detailed implementation of this step has been explained in the previous embodiment, and will not be repeated here.

In step S504, the processor 140 generates a combined summary for each document by combining multiple summary texts of each document. Specifically, the processor 140 combines all summary texts of document content segments of a certain document into a combined summary. The processor 140 directly concatenates the document summaries of each document content segment sequentially according to the order of document content segments to generate the combined summary.

In step S505, the processor 140 generates a document summary for each document by utilizing the generative model to generate a summary of the combined summary of each document. In step S506, the processor 140 utilizes the natural language model to generate another semantic feature vector of the document summary for each document, and records another semantic feature vector of each document in the database. Specifically, the processor 140 inputs the combined summary and corresponding prompt into the multimodal large language model, so that the multimodal large language model outputs a document summary of a certain document. Afterwards, the processor 140 converts this document summary into another semantic feature vector according to the natural language model. Compared to using all semantic feature vectors of all document content segments for document search, the semantic feature vector of the document summary for each document is used for quick search or preliminary search.

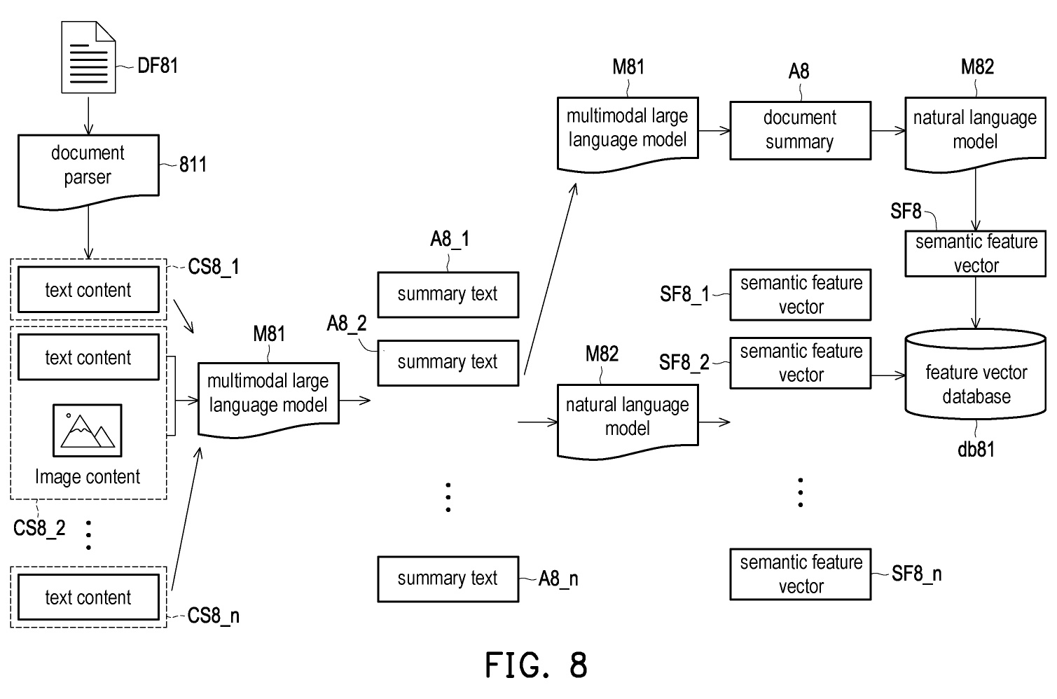

Referring to FIG. 8, which is a schematic diagram illustrating the establishment of a feature vector database according to an embodiment of the disclosure. The processor 140 may utilize the document parser 811 to obtain n document content segments CS8_1 to CS8_n of a certain document DF81. In the embodiment, the processor 140 utilizes the multimodal large language model M81 to generate n summary texts A8_1 to A8_n corresponding to the document content segments CS8_1 to CS8_n respectively. For example, the processor 140 utilizes the multimodal large language model M81 to generate the summary text A8_1 of the document content segment CS8_1, and so on.

The processor 140 utilizes the natural language model M82 to convert the summary texts A8_1 to A8_n into corresponding semantic feature vectors SF8_1 to SF8_n respectively, and record the semantic feature vectors SF8_1 to SF8_n associated with the document DF81 in the feature vector database db81. On the other hand, the processor 140 directly concatenates the summary texts A8_1 to A8_n to generate a combined summary, and input the combined summary into the multimodal large language model M81 to generate a document summary A8. The processor 140 utilizes the natural language model M82 to convert the document summary A8 into a semantic feature vector SF8, and record the semantic feature vector SF8 associated with the document DF81 in the feature vector database db81.

Returning to FIG. 5, in step S507, the processor 140 obtains a search description via the input device 110, and utilizes the natural language model to generate a search feature vector of the search description. In step S508, the processor 140 determines at least one target document related to the search description from multiple documents by comparing the search feature vector with the document summary of each document in the database. In step S509, the processor 140 determines at least one target document related to the search description from multiple documents by comparing the search feature vector with multiple semantic feature vectors of each document in the database. In other words, the processor 140 conducts a document search related to the search description based on the semantic feature vector of the document summary of the entire document, multiple semantic feature vectors corresponding to all document content segments, or a combination thereof.

In some embodiments, the processor 140 determines whether the feature similarity between all semantic feature vectors of each document and the search feature vector is greater than a threshold. When one or more feature similarity between a certain semantic feature vector of a document and the search feature vector is greater than the threshold, the processor 140 selects that document as the target document.

In step S510, the processor 140 determines a content segment index related to the search description based on multiple feature similarities corresponding to multiple semantic feature vectors of at least one target document. In some embodiments, the aforementioned content segment index is page number, paragraph number, or chapter number, etc. For instance, assuming the semantic feature vector of the document content segment on the fifth page of the target document is most similar to the search feature vector (i.e., corresponding to the highest feature similarity), the processor 140 determines the content segment index related to the search description as the fifth page. In this case, the user can also quickly know that the content of interest is located on the specific page number of the target document. Therefore, through the use of the multimodal large language model, even if the user inputs a search description related to image content, the processor 140 can still search for results that meet the user's needs based on the semantics of the search description.

In summary, in the embodiments of the disclosure, the key summary text of each document content segment is extracted through the text summarization function of the generative model, and the key summary text of each document content segment is converted into semantic feature vectors. When a search description is received, the natural language model may be utilized to convert the search description into a search feature vector. Subsequently, by comparing the search feature vector with the semantic feature vectors of each document content segment of each document in the database, target documents matching the search description can be obtained. Since the generative model can generate semantic feature vectors based on a deep understanding of the document content, it can effectively reduce the problem of inaccurate search results caused by semantic misunderstandings or synonymous variations. In addition, in the embodiments of the disclosure, as the multimodal LLM supports understanding of images in each document content segment, the multimodal LLM can simultaneously comprehend the meaning of images and corresponding text in the document content segment, thereby generating more precise key summary text. Based on this, it is possible to search for target documents that better meet user expectations, greatly improving the accuracy and convenience of document searching.

Although the present disclosure has been disclosed by the above embodiments, it is not intended to limit the present disclosure. Any person skilled in the art may make minor modifications and refinements without departing from the spirit and scope of the present disclosure. Therefore, the protection scope of the present disclosure should be defined by the appended claims and their equivalents.

What is claimed is:

1. A document search method, adapted to an electronic device storing a plurality of documents, the method comprising:
obtaining a plurality of document content segments of each of the plurality of documents;
generating a plurality of summary texts respectively corresponding to the plurality of document content segments of each of the plurality of documents utilizing a generative model;
generating a plurality of semantic feature vectors of the plurality of summary texts of each of the plurality of documents by utilizing a natural language model, and recording the plurality of semantic feature vectors of each of the plurality of documents to a database;
obtaining a search description via an input device, and generating a search feature vector for the search description by utilizing the natural language model; and
determining at least one target document related to the search description from the plurality of documents by comparing the search feature vector with the plurality of semantic feature vectors of each of the plurality of documents in the database.

2. The document search method as claimed in claim 1, wherein the plurality of document content segments comprises a first document content segment and a second document content segment, and the step of generating the plurality of summary texts respectively corresponding to the plurality of document content segments of each of the plurality of documents utilizing the generative model comprises:
generating an integrated text based on a first summary text of the first document content segment and the second document content segment; and
obtaining the second summary text of the second document content segment by utilizing the generative model to generate a summary of the integrated text,
wherein the first document content segment and the second document content segment are consecutive contents of the same document.

3. The document search method as claimed in claim 2, wherein the step of generating the integrated text based on the first summary text of the first document content segment and the second document content segment comprises:
generating the integrated text by combining the first summary text and the second document content segment when the second document content segment is pure text content.

4. The document search method as claimed in claim 2, wherein the step of generating the integrated text based on the first summary text of the first document content segment and the second document content segment comprises:
generating an image description of the pure image content by utilizing the generative model when the second document content segment is pure image content; and
generating the integrated text by combining the first summary text and the image description.

5. The document search method as claimed in claim 2, wherein the step of generating the integrated text based on the first summary text of the first document content segment and the second document content segment comprises:
generating a content description of the text-image hybrid content by utilizing the generative model when the second document content segment is text-image hybrid content; and
generating the integrated text by combining the first summary text and the content description.

6. The document search method as claimed in claim 1, further comprising:
generating a combined summary for each of the plurality of documents by combining the plurality of summary texts of each of the plurality of documents;
generating a document summary for each of the plurality of documents by utilizing the generative model to generate a summary of the combined summary for each of the plurality of documents; and
generating another semantic feature vector of the document summary of each of the plurality of documents by utilizing the natural language model to, and recording the another semantic feature vector of each of the plurality of documents in the database.

7. The document search method as claimed in claim 6, further comprising:
determining the at least one target document related to the search description from the plurality of documents by comparing the search feature vector with the another semantic feature vector of each of the plurality of documents in the database.

8. The document search method as claimed in claim 1, wherein the step of determining the at least one target document related to the search description from the plurality of documents by comparing the search feature vector with the plurality of semantic feature vectors of each of the plurality of documents in the database comprises:
calculating a plurality of feature similarities between the search feature vector and the plurality of semantic feature vectors of each of the plurality of documents; and
determining the at least one target document related to the search description from the plurality of documents according to the plurality of feature similarities corresponding to each of the plurality of documents.

9. The document search method as claimed in claim 8, wherein the step of determining the at least one target document related to the search description from the plurality of documents by comparing the search feature vector with the plurality of semantic feature vectors of each of the plurality of documents further comprises:
determining a content segment index related to the search description according to the plurality of feature similarities corresponding to the plurality of semantic feature vectors of the at least one target document.

10. The document search method as claimed in claim 1, wherein the generative model comprises a Multimodal Large Language Model.

11. An electronic device, comprising:
an input device;
a storage device, recording a plurality of documents and a plurality of instructions; and
a processor, connected to the input device and the storage device, configured to execute the instructions to:
obtain a plurality of document content segments of each of the plurality of documents;
generate a plurality of summary texts respectively corresponding to the plurality of document content segments of each of the plurality of documents utilizing a generative model;
generate a plurality of semantic feature vectors of the plurality of summary texts of each of the plurality of documents by utilizing a natural language model, and recording the plurality of semantic feature vectors of each of the plurality of documents to a database;
obtain a search description via an input device, and generating a search feature vector for the search description by utilizing the natural language model; and
determine at least one target document related to the search description from the plurality of documents by comparing the search feature vector with the plurality of semantic feature vectors of each of the plurality of documents in the database.
